(19) United States
(12) Patent Application Publication
(10) Pub. No.: US 2026/0126408 A1
(43) Pub. Date: May 7, 2026

(54) NANOFIBER SENSOR MICROHEATER

(71) Applicant: Gentex Corporation, Zeeland, MI (US)

(72) Inventor: Christopher S. Adams, Salt Lake City, UT (US)

(73) Assignee: Gentex Corporation, Zeeland, MI (US)

(21) Appl. No.: 19/368,124

(22) Filed: Oct. 24, 2025

Related U.S. Application Data
(60) Provisional application No. 63/716,366, filed on Nov. 5, 2024.

(51) Int. Cl. G01N 27/12

(52) U.S. Cl. CPC G01N 27/123

(57) ABSTRACT

A sensor assembly for detecting a presence of an analyte includes a detector and a microheater. The detector includes an electrode layer including interdigitated electrodes and nanofibers that are formed of a fiber material exhibiting an electrical signal that changes based on exposure to the analyte. The microheater is coupled to the detector and includes a heating element that is capable of heating at least a portion of the detector to a temperature that reduces a quantity of water molecules in a region proximate the nanofibers.

### CROSS-REFERENCE TO RELATED APPLICATION

This application claims priority to and the benefit under 35 U.S.C. § 119(e) of U.S. Provisional Application No. 63/716,366, filed on Nov. 5, 2024, entitled “NANOFIBER SENSOR MICROHEATER,” the disclosure of which is hereby incorporated herein by reference in its entirety.

### FIELD OF THE DISCLOSURE

The present disclosure generally relates to a sensor microheater and, more particularly, a sensor assembly with a microheater.

### SUMMARY OF THE DISCLOSURE

According to one aspect of the present disclosure, a sensor assembly for detecting a presence of an analyte includes a detector and a microheater. The detector includes an electrode layer including interdigitated electrodes and nanofibers that are formed of a fiber material exhibiting an electrical signal that changes based on exposure to the analyte. The microheater is coupled to the detector and includes a heating element that is capable of heating at least a portion of the detector to a temperature that reduces a quantity of water molecules in a region proximate the nanofibers.

According to another aspect of the present disclosure, a sensor assembly for detecting a presence of an analyte includes a detector and a microheater. The sensor assembly further includes a housing and a humidity sensor configured to detect a humidity level within the housing. The detector includes an electrode layer including interdigitated electrodes and nanofibers that are formed of a fiber material exhibiting an electrical signal that changes based on exposure to the analyte. The microheater is coupled to the detector and includes a heating element that is capable of heating at least a portion of the detector to a temperature that reduces a quantity of water molecules in a region proximate the nanofibers. A control circuit is in operable communication with the humidity sensor. The control circuit is configured to receive the detected humidity level and energize the microheater based on the detected humidity level.

According to yet another aspect of the present disclosure, a sensor assembly for detecting a presence of an analyte includes a detector and a microheater. The sensor assembly further includes a housing. The detector includes an electrode layer including interdigitated electrodes and nanofibers that are formed of a fiber material exhibiting an electrical signal that changes based on exposure to the analyte. The microheater is coupled to the detector and includes a heating element that is capable of heating at least a portion of the detector to a temperature that reduces a quantity of water molecules in a region proximate the nanofibers.

The present disclosure generally provides a sensor microheater and, more particularly, a sensor assembly with a microheater. The sensor assembly may include nanofibers that are formed of a fiber material exhibiting an electrical signal that changes based on exposure to the analyte. The microheater may control the temperature around the nanofibers to prevent or reduce the accumulation of water molecules. More particularly, when the nanofibers are exposed to humidity, the changes in the electrical signals can be hindered and unpredictable, making quantification of the analyte difficult. The microheater, therefore, heats a portion of the nanofibers to the temperature which is high enough to remove the water molecules and/or dry the nanofibers, but low enough not to affect the operational state of the nanofibers.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a schematic view of a sensor assembly with a microheater of a first construction, according to an aspect of the present disclosure;

FIG. 2A is a front view of a sensor assembly with a microheater of a first construction, according to an aspect of the present disclosure;

FIG. 2B is a front view of a sensor assembly in a disassembled condition with a microheater of a second construction, according to an aspect of the present disclosure;

FIG. 2C is a front view of a sensor assembly in a disassembled condition with a microheater of a third construction, according to an aspect of the present disclosure;

FIG. 3A is a graphical representation of humidity effects on a sensor assembly without a microheater, according to an aspect of the present disclosure;

FIG. 3B is a graphical representation of humidity effects on a sensor assembly with a microheater at a 10 V bias, according to an aspect of the present disclosure;

FIG. 3C is a graphical representation of humidity effects on a sensor assembly with a microheater at a 15 V bias, according to an aspect of the present disclosure; and

FIG. 3D is a graphical representation of humidity effects on a sensor assembly with a microheater at a 20 V bias, according to an aspect of the present disclosure.

### DETAILED DESCRIPTION

The present illustrated embodiments reside primarily in combinations of method steps and apparatus components related to a sensor assembly with a microheater. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

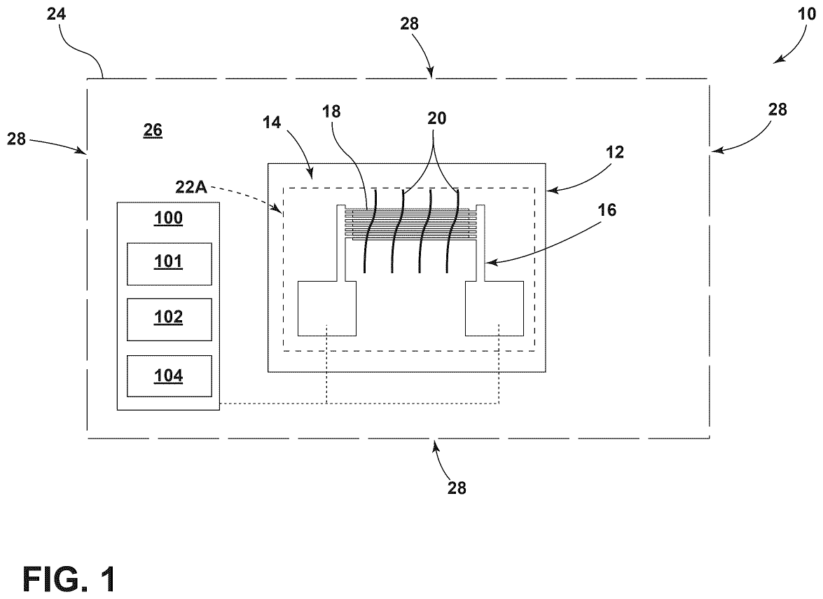

For purposes of description herein, the terms “upper,” “lower,” “right,” “left,” “rear,” “front,” “vertical,” “horizontal,” and derivatives thereof, shall relate to the disclosure as oriented in FIG. 1. Unless stated otherwise, the term “front” shall refer to the surface of the device closer to an intended viewer of the device, and the term “rear” shall refer to the surface of the device further from the intended viewer of the device. However, it is to be understood that the disclosure may assume various alternative orientations, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

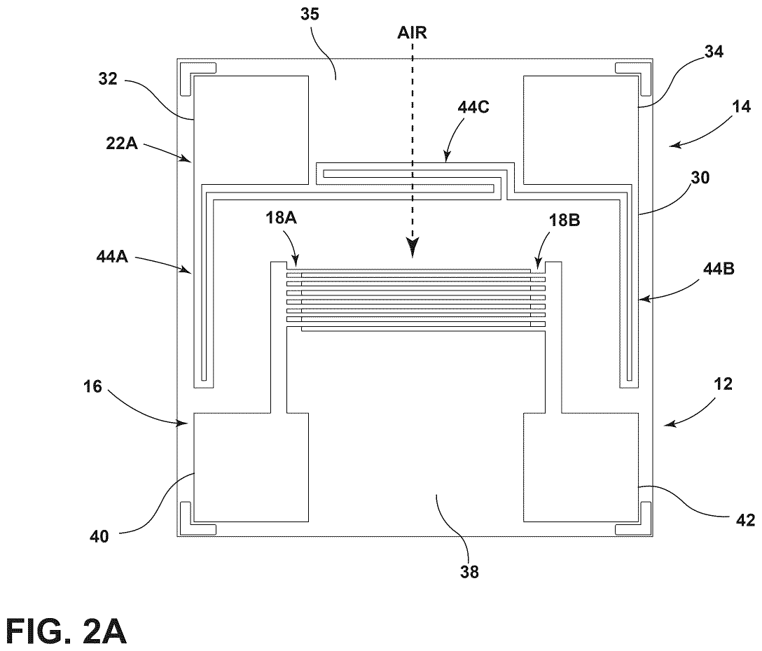

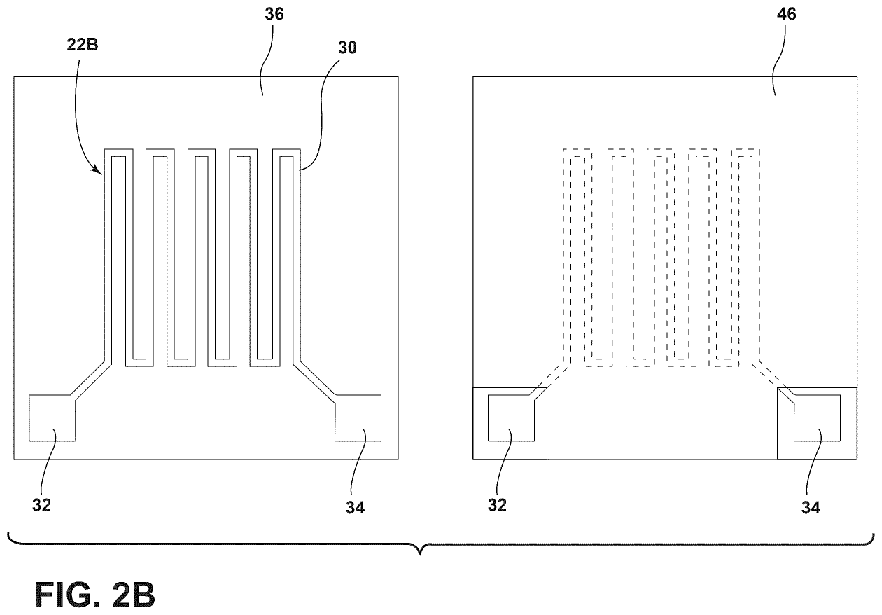

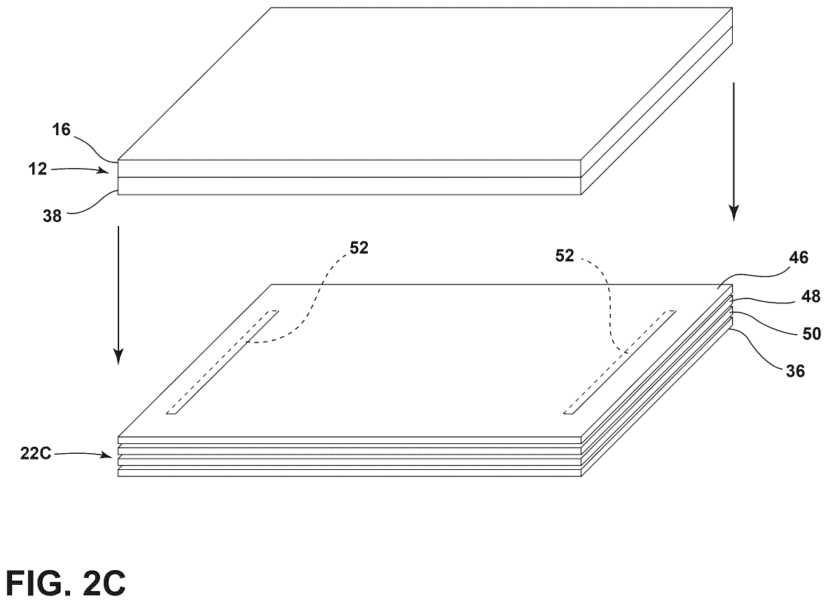

Referring to FIGS. 1-2A reference numeral 10 generally designates a sensor assembly for detecting a presence of an analyte. The sensor assembly 10 includes a detector 12 and a microheater 14. The detector 12 includes an electrode layer 16 including interdigitated electrodes 18 and nanofibers 20 that are formed of a fiber material exhibiting an electrical signal that changes based on exposure to the analyte. The microheater 14 is coupled to the detector 12 and includes a heating element 22A that is capable of heating at least a portion of the detector 12 to a temperature that reduces a quantity of water molecules in a region proximate the nanofibers 20.

The microheater 14 controls the temperature around the detector 12 to prevent or reduce the accumulation of water molecules. More particularly, when the nanofibers 20 are exposed to humidity, the changes in the electrical signals can be hindered and unpredictable, making quantification of the analyte difficult. The microheater 14, therefore, heats a portion of the detector 12 (e.g., the nanofibers 20) to the temperature, which is high enough to remove the water molecules and/or dry the nanofibers 20, but low enough not to affect the operational state of the nanofibers 20. The heating element 22A may be configured to be heated to and maintained within 1° C. to 3° C. of a target temperature. For example, the heating element 22A may be configured to be heated to the target temperature, the target temperature being between about 80° C. and about 150° C., between about 100° C. and about 150° C., between about 100° C. and 120° C., between about 110° C. and 130° C., at least 100° C., about or less than 150° C., or about 100° C. Generally speaking, temperatures above 150° C. can degrade certain types of nanofibers 20 and temperatures above 100° C. are high enough to significantly reduce the accumulation of water molecules and, as a result, increase the uniformity of changes in the electrical signals of the nanofibers 20. It should be appreciated that while the microheater 14 may be configured to heat the nanofibers 20, the microheater 14 may further be configured to heat the electrode layer 16 to the previously described temperatures and temperature ranges. More particularly, similar to how current through the nanofiber 20 increases in the presence of higher humidity, the current between the electrodes 18 (without nanofibers 20) also increases with higher humidity. In theory, this current should be 0 amps since there is a gap between all of the electrodes 18. In practice, the current is on the order of femto-amps at 0% RH and increases to pico or nano-amps in humid conditions. The hydrophobic passivation layer repels water and keeps the leakage current in the femto-amp range. In some embodiments, to mitigate these negative impacts to the interdigitated electrodes 18, the interdigitated electrodes 18 may be subjected to a passivation process with octadecyltrichlorosilane prior to assembly.

The uniformity of changes in the electrical signals of the nanofibers 20 is needed to accurately and uniformly detect the presence and, in some embodiments, quantities of the analyte. The nanofibers 20 are deposited on the interdigitated electrodes 18 to form an electrode-nanofiber array. The nanofibers 20 have a very high 3-dimensional surface area that is able to interact with the analyte. The nanofibers 20 may be doped with a light source to enhance electrical conductivity of the nanofibers 20. The interaction of the nanofibers 20 with the analyte changes the measured electrical characteristics of the detector 12. An increase or decrease in an electrical characteristic, including measured current or effective resistance of the electrode-nanofiber array, occurs as a result of these interactions. The detector 12 may be configured to detect the presence of a variety of types of analytes (e.g., a target analyte), for scenarios where it is beneficial to detect the presence of airborne materials. More particularly, the detector 12 may be configured to detect different analytes based on the selection of a dopant that may be incorporated into the fiber material of the nanofibers 20. The fiber material may be organic. In this manner, the detector 12 may be configured to detect analytes such as airborne chemicals, toxins, combustion by-products, and explosive materials, and/or the like. The change in electrical signal may include changes in conductivity, resistivity, or other detectable characteristics, such as changes in the mass or weight of the nanofibers 20, based on exposure to the analyte. In some embodiments, the nanofibers 20 may be formed of a derivative of organic pigment perylene-3,4,9,10-tetracarboxylic acid diimide (“PTCDI”) base material.

With reference now specifically to FIG. 1, the sensor assembly 10 may include a housing 24 defining an internal chamber 26 containing both the detector 12 and the microheater 14. The housing 24 may define one or more air vents 28 (e.g., two or more, three or more, etc.) that allow ambient air to enter and be exposed to the nanofibers 20. While not explicitly shown herein, it should be appreciated that the detector 12 may include a plurality of discrete electrode-nanofiber arrays with at least two electrode-nanofiber arrays that are configured to detect different types of analytes. The housing 24 may be configured to be modular or permanently mounted to an environment, such as a wall, ceiling, vehicle, etc. In some embodiments, housing 24 may be small enough and light enough to be wearable by a user or carried by a user within the environment, such as a watch, necklace, and/or the like. In such implementations, the control circuit 100 and components of the sensor assembly 10 may receive power from a battery module 101. For example, the battery module 101 may be rechargeable and contained in the wearable device or other module or static implementation of the sensor assembly 10. However, it should be appreciated that the sensor assembly 10 may utilize a more permanent power source. For example, the sensor assembly 10 may be configured to gain power through the power grid of an environment, a vehicle control system, and/or the like. In some implementations, the housing 24 may be incorporated into a vehicle. The sensor assembly 10 may further include a control circuit 100 which may include a processor and memory or logic scheme. The control circuit 100 may include an alarm module 102 that is configured to generate an alarm if the target analyte and/or a threshold quantity of the target analyte is detected. In some embodiments, the control circuit 100 may further include a humidity sensor 104 or some other form of water sensing module. In some embodiments, the control circuit 100 receives the detected humidity level and/or the presence of water and generates a command to energize the microheater 14 and heat the heating element 22A. In this manner, the microheater 14 may only be utilized based on the detected presence and/or quantity of the humidity and/or water. However, it should be appreciated that the microheater 14 may be configured to be energized at all times during operation of the sensor assembly 10.

With reference now to FIGS. 2A-2C, the microheater 14 may include heating elements of a variety of constructions. In FIG. 2A, the heating element 22A includes a heating trace 30 that extends between a first heating conduction terminal 32 and a second heating conduction terminal 34. The heating trace 30 in the first construction is spaced from and extends at least partially around a perimeter of the interdigitated electrodes 18. In this manner, the heating element 22A and the electrode layer 16 may be located on a common substrate 35. More particularly, the electrode layer 16 may include a first set of interdigitated electrodes 18A extending from a first detector terminal 40 and a second set of interdigitated electrodes 18B extending from a second detector terminal 42. The common substrate 35 may be formed of fused silica. One of the first and second detector terminals 40, 42 may be cathodic and the other of the first and second detector terminals 40, 42 may be anodic. A voltage differential or bias (e.g., about 7 volts) is applied to the first and second detector terminals 40, 42, however, there is nominal transfer of current because the first set of interdigitated electrodes 18A is spaced from the second set of interdigitated electrodes 18B. However, the nanofibers 20 are deposited on and traverse both the first set of interdigitated electrodes 18A and the second set of interdigitated electrodes 18B. The nanofibers 20 are naturally resistive, but when in contact with the analyte, an increase or decrease is observed in the current between the first and second detector terminals 40, 42. The heating trace 30 is electrically isolated from the electrode layer 16 by being spaced around the perimeter. The heating trace 30 may include a long singular trace in a pattern with a first double trace segment 44A extending along a first side of the perimeter of the interdigitated electrodes 18 (e.g. the first set of interdigitated electrodes 18A) and a second double trace segment 44B extending along a second side (e.g., opposite side) of the perimeter of the interdigitated electrodes 18 (e.g., the second set of interdigitated electrodes 18B). In some embodiments, a triple trace segment 44C may be on a third side the perimeter of the interdigitated electrodes 18. The triple trace segment 44C may be aligned with at least one of the air vents 28 such that air flows over the triple trace segment 44C and is heated before passing over the nanofibers 20.

With reference now to FIG. 2B, a heating element 22B of a second construction is depicted. In the second construction, the heating trace 30 extends along a pattern that is at least partially aligned with the interdigitated electrodes 18. While the heating trace 30 of the heating element 22B is depicted in a radiator pattern, it should be appreciated that other patterns may be utilized, for example, the heating trace 30 may be deposited in a spiral pattern, a serpentine pattern, or any number of patterns. As depicted, when the heating trace 30 overlaps with the interdigitated electrodes, the heating trace 30 may be located on a heater substrate 36 and the interdigitated electrodes 18 may be located on a detector substrate 38, similar to that depicted in FIG. 2C. While the heating trace 30 is spaced from the electrode layer 16 by the detector substrate 38, in order to electrically isolate the heating trace 30 from the electrode layer 16, the microheater 14 may include a passivation layer 46. In this manner, the heating trace 30 may be sandwiched between the heater substrate 36 and the passivation layer 46, with the passivation layer 46 between the heating trace 30 and the detector 12. The passivation layer 46 may be formed, for example, of silicon nitride.

With reference now to FIGS. 2A and 2B, in the first and second constructions that utilize the heating trace 30, the heating trace 30 may be formed of platinum with a chromium adhesion layer. The heating trace 30 utilized in the sensor assembly 10 may have various lengths depending on the size of the region to be heated. In some embodiments, the heating trace 30 may have a width of about 20 μm to about 150 μm, for example, about 30 μm to about 125 μm, about 30 μm to about 75 μm, or about 50 μm. In addition to the width, the heating trace 30 may have a thickness (e.g., the platinum only) of about 50 nm to about 500 nm, for example, about 75 nm to about 400 nm, about 200 nm to about 300 nm, or about 250 nm. In this manner, the heating trace 30 may have about 30 to about 2200 ohms of resistance, for example, between about 600 and 800 ohms, over 650 ohms, or about 715 ohms. In some embodiments, the heating trace 30 is located within a channel or recess of the heater substrate 36.

With reference now to FIG. 2C, a heating element 22C of a third construction is depicted in a disassembled condition that, when assembled, components of which are joined in the direction of the depicted arrows. In the third construction, rather than employing the heating trace 30, the heating element 22C includes a heating element substrate 48. The heating element substrate 48 may generally be aligned with the interdigitated electrodes 18 (e.g., similar to the second construction) or spaced around the perimeter (e.g., similar to the first construction). The heating element substrate 48 may be formed of a semi-conductive material such as polysilicon with a dopant additive (e.g., boron) to optimize the resistivity of the heating element substrate 48 based on the amount of dopant additive. The heating element substrate 48 may be deposited on (e.g., grown on) the heater substrate 36 or may be otherwise integral with the heater substrate 36, where the heating element substrate 48 is located on a different side of the heater substrate 36 than the interdigitated electrodes 18. The heating element substrate 48 may include a conductive film 50, such as indium-tin-oxide (“ITO”), deposited thereon or used alternatively to the semi-conductive material. Conductive contacts or other conductive intermediaries may be utilized in addition or alternatively to the conductive film 50. For example, substrate contacts 52 may be located on and extend along edges of the heating element substrate 48, corners of the heating element substrate 48, and/or other locations of the heating element substrate 48. Further, it should be appreciated that, in some embodiments, the heating element substrate 48 may include other conductive materials, such as ITO located directly on the heater substrate 36 (e.g., without the polysilicon with a dopant additive). Depending on the amount of dopant additive, the presence or absence of the conductive film 50, and a thickness, width, and length of the heating element substrate 48, the voltage differential or bias between the substrate contacts 52 may be between about 3V and about 30V, for example, about 5V, about 12V or about 24V.

The various heating elements 22A-22C may be assembled by a variety of processes. For example, for heating elements 22A and 22B, the heating trace 30 may be deposited on the heater substrate 36 via a sputter deposition process or, more generally, a physical vapor deposition process (“PVD”). In some embodiments, the heating trace 30 is located within a recessed channel in the heater substrate 36 such that the heater substrate 36 and heating traces 30 exhibit a planar surface. The recessed channels may be formed via an etching process, such as plasma etching, or wet etching. The heating element substrate 48 (e.g., the semi-conductive material and/or ITO) may be, as previously indicated, grown onto the heater substrate 36, deposited as a film, or assembled via other techniques.

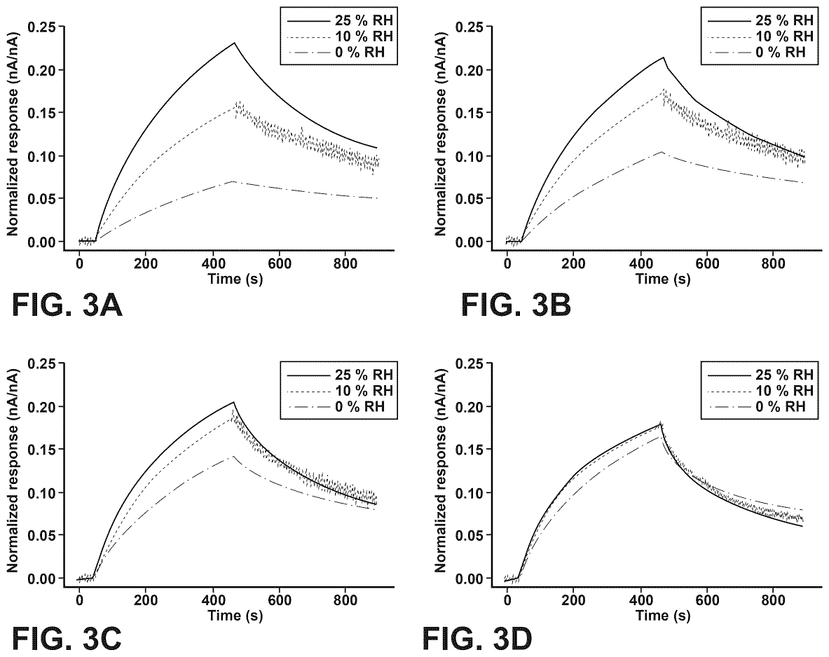

FIGS. 3A-3D graphically depict the benefits of the microheater 14 incorporated into the sensor assembly 10. In each of these graphs, each line represents the detector's 12 (e.g., the nanofibers 20) response to the same amount of the analyte, but under different humidity conditions. The top line is exposed to 25% humidity conditions, the middle line is exposed to 10% humidity conditions, and the bottom line is exposed to 0% humidity conditions. FIG. 3A is a graphical representation of humidity effects on a detector without the microheater 14. The response from the detector 12 (e.g., the nanofibers 20) is noticeably different, in this case, becoming greater as the nanofibers 20 are exposed to a greater humidity. The difference in response is problematic and can lead to incorrect or inaccurate information. The graph in FIG. 3B depicts humidity effects on a sensor assembly 10 with a microheater 14 at a 10 V bias, which heats the microheater 14 (e.g., the electrodes 18 or heater substrate 48) to about 50° C. As shown, the response from the detector 12 (e.g., the nanofibers 20) starts to become more uniform. The graph in FIG. 3C depicts humidity effects on a sensor assembly 10 with a microheater 14 at a 15 V bias, which heats the microheater 14 (e.g., the electrodes 18 or heater substrate 48) to about 80° C. As shown, the response from the detector 12 (e.g., the nanofibers 20) becomes more uniform than those depicted in FIGS. 3A and 3B. The graph in FIG. 3D depicts humidity effects on a sensor assembly 10 with a microheater 14 at a 20 V bias, which heats the microheater 14 (e.g., the electrodes 18 or heater substrate 48) to about 115° C. As shown, the response from the detector 12 (e.g., the nanofibers 20) is almost completely uniform. In FIG. 3D the detector 12 (e.g., via the microheater 14) is heated to about 115° C. While the graphs provided in FIGS. 3A-3D are representative of the benefits of incorporating the microheater 14, it should be appreciated that different voltage biases may be utilized in addition to those depicted. Generally speaking, the microheater 14 will be beneficial as long as the humidity is reduced and the response from the detector 12 (e.g., the nanofibers 20) becomes more uniform as the humidity becomes less and less.

The disclosure herein is further summarized in the following paragraphs and is further characterized by combinations of any and all of the various aspects described therein.

According to one aspect of the present disclosure, a sensor assembly for detecting a presence of an analyte includes a detector and a microheater. The detector includes an electrode layer including interdigitated electrodes and nanofibers that are formed of a fiber material exhibiting an electrical signal that changes based on exposure to the analyte. The microheater is coupled to the detector and includes a heating element that is capable of heating at least a portion of the detector to a temperature that reduces a quantity of water molecules in a region proximate the nanofibers.

According to another aspect, the heating element is configured to be heated to between 80° C. and 150° C.

According to yet another aspect, the heating element is configured to be heated to between 100° C. and 150° C.

According to still another aspect, the heating element includes a heating trace that extends between a first heating conduction terminal and a second heating conduction terminal.

According to another aspect, the heating trace is spaced from and extends at least partially around a perimeter of the interdigitated electrodes.

According to yet another aspect, the heating trace extends between the first heating conduction terminal and the second heating conduction terminal in a pattern that is at least partially aligned with the interdigitated electrodes.

According to still another aspect, the microheater includes a passivation layer located between the heating trace and the interdigitated electrodes.

According to still yet another aspect, the heating element includes a heating element substrate that is aligned with the interdigitated electrodes.

According to another aspect, the heating element substrate is formed of p-type silicon or indium tin oxide (“ITO”).

According to yet another aspect, the microheater includes a passivation layer located between the heating element substrate and the interdigitated electrodes.

According to still yet another aspect, the fiber material is organic.

According to another aspect of the present disclosure, a sensor assembly for detecting a presence of an analyte includes a detector and a microheater. The sensor assembly further includes a housing and a humidity sensor configured to detect a humidity level within the housing. The detector includes an electrode layer including interdigitated electrodes and nanofibers that are formed of a fiber material exhibiting an electrical signal that changes based on exposure to the analyte. The microheater is coupled to the detector and includes a heating element that is capable of heating at least a portion of the detector to a temperature that reduces a quantity of water molecules in a region proximate the nanofibers. A control circuit is in operable communication with the humidity sensor. The control circuit is configured to receive the detected humidity level and energize the microheater based on the detected humidity level.

According to another aspect, the fiber material is formed of a derivative of organic pigment perylene-3,4,9,10-tetracarboxylic acid diimide.

According to yet another aspect, the control circuit is configured to energize the microheater once the detected humidity level reaches a threshold level.

According to still yet another aspect, the heating element includes a heating trace that extends between a first heating conduction terminal and a second heating conduction terminal, the heating trace includes a long singular trace in a pattern with at least one double trace segment.

According to another aspect, the heating element is configured to be heated to at or below 150° C.

According to yet another aspect, the heating element includes a heating element substrate aligned with the electrodes with a conductive film.

According to yet another aspect of the present disclosure, a sensor assembly for detecting a presence of an analyte includes a detector and a microheater. The sensor assembly further includes a housing. The detector includes an electrode layer including interdigitated electrodes and nanofibers that are formed of a fiber material exhibiting an electrical signal that changes based on exposure to the analyte. The microheater is coupled to the detector and includes a heating element that is capable of heating at least a portion of the detector to a temperature that reduces a quantity of water molecules in a region proximate the nanofibers.

According to another aspect, a wearable device includes a sensor assembly for detecting a presence of an analyte. The sensor assembly includes a detector and a microheater. The sensor assembly further includes a housing. The detector includes an electrode layer including interdigitated electrodes and nanofibers that are formed of a fiber material exhibiting an electrical signal that changes based on exposure to the analyte. The microheater is coupled to the detector and includes a heating element that is capable of heating at least a portion of the detector to a temperature that reduces a quantity of water molecules in a region proximate the nanofibers.

According to yet another aspect, the heating element includes a heating trace formed of platinum with a chromium adhesion layer.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

It is also important to note that the construction and arrangement of the elements of the disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures and/or members or connectors or other elements of the system may be varied, and the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the concepts of the present disclosure, and further it is to be understood that such concepts are intended to be covered by the following claims unless these claims by their language expressly state otherwise.

What is claimed is:

1. A sensor assembly for detecting a presence of an analyte, the sensor assembly comprising:
a detector including an electrode layer including interdigitated electrodes and nanofibers that are formed of a fiber material exhibiting an electrical signal that changes based on exposure to the analyte; and
a microheater coupled to the detector, the microheater including a heating element that is capable of heating at least a portion of the detector to a temperature that reduces a quantity of water molecules in a region proximate the nanofibers.

2. The sensor assembly of claim 1, wherein the heating element is configured to be heated to between 80° C. and 150° C.

3. The sensor assembly of claim 2, wherein the heating element is configured to be heated to between 100° C. and 150° C.

4. The sensor assembly of claim 1, wherein the heating element includes a heating trace that extends between a first heating conduction terminal and a second heating conduction terminal.

5. The sensor assembly of claim 4, wherein the heating trace is spaced from and extends at least partially around a perimeter of the interdigitated electrodes.

6. The sensor assembly of claim 4, wherein the heating trace extends between the first heating conduction terminal and the second heating conduction terminal in a pattern that is at least partially aligned with the interdigitated electrodes.

7. The sensor assembly of claim 6, wherein the microheater includes a passivation layer located between the heating trace and the interdigitated electrodes.

8. The sensor assembly of claim 1, wherein the heating element includes a heating element substrate that is aligned with the interdigitated electrodes.

9. The sensor assembly of claim 8, wherein the heating element substrate is formed of p-type silicon or indium tin oxide (“ITO”).

10. The sensor assembly of claim 9, wherein the microheater includes a passivation layer located between the heating element substrate and the interdigitated electrodes.

11. The sensor assembly of claim 1, wherein the fiber material is organic.

12. A sensor assembly for detecting a presence of an analyte, the sensor assembly comprising:
a housing;
a humidity sensor configured to detect a humidity level within the housing;
a detector including an electrode layer including electrodes and nanofibers that are formed of a fiber material exhibiting an electrical signal that changes based on exposure to the analyte;
a microheater coupled to the detector, the microheater including a heating element that is capable of heating at least a portion of the detector to a temperature that reduces a quantity of water molecules in a region proximate the nanofibers; and
a control circuit in operable communication with the humidity sensor, the control circuit configured to:
receive the detected humidity level; and
energize the microheater based on the detected humidity level.

13. The sensor assembly of claim 12, wherein the fiber material is formed of a derivative of organic pigment perylene-3,4,9,10-tetracarboxylic acid diimide.

14. The sensor assembly of claim 13, wherein the control circuit is configured to energize the microheater once the detected humidity level reaches a threshold level.

15. The sensor assembly of claim 13, wherein the heating element includes a heating trace that extends between a first heating conduction terminal and a second heating conduction terminal, the heating trace includes long singular trace in a pattern with at least one double trace segment.

16. The sensor assembly of claim 13, wherein the heating element is configured to be heated to at or below 150° C.

17. The sensor assembly of claim 13, wherein the heating element includes a heating element substrate aligned with the electrodes with a conductive film.

18. A sensor assembly for detecting a presence of an analyte, the sensor assembly comprising:
a housing;
a detector including an electrode layer including interdigitated electrodes and nanofibers that are formed of a fiber material exhibiting an electrical signal that changes based on exposure to the analyte; and
a microheater coupled to the detector, the microheater including a heating element that is capable of heating at least a portion of the detector to a temperature at or below 150° C. that reduces a quantity of water molecules in a region proximate the nanofibers.

19. A wearable device including the sensor assembly of claim 18.

20. The sensor assembly of claim 18, wherein the heating element includes a heating trace formed of platinum with a chromium adhesion layer.
